(19) United States
(12) Patent Application Publication
(10) Pub. No.: US 2006/0016565 A1
(43) Pub. Date: Jan. 26, 2006

(54) Floating pin lamination plate system for multilayer circuit boards

(76) Inventors: Gary A. Hoeppel, Mount Albert, CA (US); Robert P. McGarry JR., Silver Lake, OH (US)

Correspondence Address: Ralph A. Dowell of DOWELL & DOWELL P.C., 2111 Eisenhower Ave., Suite 406, Alexandria, VA, 22314, US

(21) Appl. No.: 10/895,973

(22) Filed: Jul. 22, 2004

(51) Int. Cl. B30B 15/34; B30B 5/02; B32B 37/06

(52) U.S. Cl. 156/580; 156/583.1; 100/315

(57) ABSTRACT

A lamination plate system for registering printed circuit board layers in a lamination press, the layers having a plurality of corresponding registration holes formed therein, the system comprising: a plurality of respective pins for passing through the registration holes to register the layers vertically, each pin having a head and a shaft; and, top and bottom caul plates having a plurality of corresponding holes and bores formed therein, respectively, each hole and bore for receiving the shaft and head of a pin, respectively; wherein the pins, holes, and bores are sized to allow for horizontal movement of the layers when positioned between the top and bottom caul plates during lamination.

### FIELD OF THE INVENTION

This invention relates to the field of multilayer circuit board lamination, including flexible and rigid-flex circuit board lamination, and more specifically, to a lamination plate system having floating registration pins for improved circuit board registration.

### BACKGROUND OF THE INVENTION

Traditionally, printed circuit boards consist of a sheet or board of electrically resistive material on which is printed a wiring circuit. Various electrical components such as integrated circuits, discrete components and connectors are then soldered to the wiring circuit via holes drilled through the board. Double-sided printed circuit boards comprise a board having a wiring circuit printed on both sides thereof.

Newer multilayered printed circuit boards consist of multiple individual single-sided or double-sided printed circuit boards electrically insulated from one another and laminated together. Holes are drilled through the board at planned locations to allow interconnection of one printed circuit with one or more of the other printed circuits. After any drill smear is removed from the edges of the holes, the holes are then plated-through to electrically interconnect the individual printed circuits. The multilayer board is then ready to receive the various electrical components via the holes in the board. After inserting the leads of the components into the holes, the components are soldered to the printed circuits.

One of the many challenges associated with the manufacture of multilayered circuit boards lies in the method by which the boards are laminated. Often, failure of a circuit board is the result of improper or inadequate lamination of the layers which may result in insecure lamination or delamination during manufacture or use. As such, proper lamination is critical to the successful manufacture of circuit boards.

Consequently, several methods have been used to laminate circuit boards. One common method is to begin with non-conductive boards which are coated on both sides with copper or similar conductive material. Each side of the double-sided board is then coated with an etch-resistant/photo-resist material. Using a photographic negative of the desired printed circuit, the photo-resist is exposed and developed to remove the photo-resist in all areas except for the lines which will constitute the printed circuit. The board is then etched to remove the copper coating in all areas except for such lines, thereby producing copper lines defining the printed circuit. The printed circuits formed on each side of the double-sided board are registered with respect to one another. Usually, registration holes are provided to assure that the printed circuits will be registered when the boards are laminated together.

During the actual step of lamination, the boards are stacked on a platen or caul plate. An epoxy-impregnated, non-conductive material is placed between each adjacent board and then another platen is placed on top of the sandwiched lamination. The non-conductive material is selected to ensure that the printed circuit on one board is electrically isolated from that of the adjacent board. The bottom platen usually includes registration pins which allow the boards to be registered with respect to one another, thereby also registering the printed circuits.

The sandwiched platens/printed circuit boards/epoxy-impregnated non-conductive material, commonly referred to as a “book”, is placed into a heated, hydraulic press. The press is then operated to heat and forcibly compress the book to activate and rapidly cure the epoxy contained within the non-conductive material. After curing the epoxy at the desired temperature and pressure, the book is released from the press and, after cooling, the platens are removed revealing the produced circuit board. After drilling the circuit board, the holes are desmeared and then plated-through. The circuit board is then ready for receiving electrical components.

In other variations of the lamination method, the book may comprise inner layers composed of single-sided boards, and/or the adhesive layer may comprise epoxy-glass, acrylic, or other materials.

Thus, multilayered printed circuit boards comprise a number of circuit layers separated by insulation layers which are laminated together to form a solid board. These circuit boards are laminated together by being placed between a pair of platens within a hydraulic press. The press is heated to a predetermined temperature and a pressure is applied for a predetermined time.

More recently, flexible (“flex”) circuit boards have emerged as have combined rigid and flexible (“rigid-flex”) circuit boards. In a rigid circuit board, like those discussed above, each circuit layer includes an insulation layer made from a rigid material. In a flexible circuit board, each circuit layer consists of an insulation layer made from a flexible sheet of material. In the past, multilayered printed circuit boards have either been rigid or flexible. However, modern multilayered printed circuit boards may have both rigid and flexible portions. As such, prior lamination methods have become unsatisfactory for several reasons.

Firstly, the lamination of flexible and rigid-flex circuit boards presents a number of difficult technical problems relating to thermal expansion and the even application of pressure during the lamination process. The portions of these circuit boards which are rigid have coefficients of thermal expansion that are different than the portions which are flexible. Furthermore, the portions which are flexible are typically much thinner than the rigid portions hence requiring special inserts to ensure that the press applies a uniform pressure to the entire circuit board during the lamination process.

Another problem relates to the spacing between the copper circuit traces on the individual circuit layers. Recently, circuit traces have become finer and more closely spaced and it is necessary that the insulation material flow uniformly into the spaces between all circuit traces during the lamination process. In this manner, the insulating layer functions not only to insulate the circuit traces on one layer of a multilayered board from the facing traces on an adjacent layer, but also serves to insulate the individual traces on each multilayered board from each other. The steel platens of conventional hydraulic presses, being rigid, will not conform to irregularities in the multilayers and are often not capable of applying a uniform pressure which will cause the insulation material to flow uniformly into all of the spaces between the circuitry. Therefore, air may become trapped within the layers. This air creates spaces between circuit traces which are not filled with insulation material, resulting in possible shorts and rendering the multilayered flexible or rigid-flex circuit board subject to possible failure during use.

In attempts to overcome these problems, some manufacturers have produced dedicated, product specific, lamination plates for their flexible and rigid-flex circuit boards. These dedicated plates often include a number of fixed registration pins surrounding and located as near as possible to the etched, printed pattern of the circuit boards for supporting the dielectric during lamination.

However, these dedicated plate systems also have several drawbacks. The use of dedicated, product specific plates increases costs and storage requirements. In addition, the fixed pins of these systems may unduly constrain the movement of circuit board materials during lamination. The expansion forces of the laminate may deform the registration holes when the pins are fixed in place. Depending on the material chosen for the registration pins, e.g. steel or aluminium, expansion forces can also act upon the laminate when the lamination plates expand when heated. These forces may produce imperfections in the final circuit board product.

A need therefore exists for an improved system for laminating multilayer circuit boards including flexible and rigid-flex circuit boards. Accordingly, a solution that addresses, at least in part, the above and other shortcomings is desired.

### SUMMARY OF THE INVENTION

According to one aspect of the invention, there is provided a lamination plate system for registering printed circuit board layers in a lamination press, the layers having a plurality of corresponding registration holes formed therein, the system comprising: a plurality of respective pins for passing through the registration holes to register the layers vertically, each pin having a head and a shaft; and, top and bottom caul plates having a plurality of corresponding holes and bores formed therein, respectively, each hole and bore for receiving the shaft and head of a pin, respectively; wherein the pins, holes, and bores are sized to allow for horizontal movement of the layers when positioned between the top and bottom caul plates during lamination.

Preferably, the registration holes in the layers correspond to ones of respective holes and bores in the top and bottom caul plates.

Preferably, the system further includes first and second separator plates positioned between the top and bottom caul plates, respectively, and the layers, the first and second separator plates having holes formed therein corresponding to the holes formed in the top caul plate.

Preferably, the holes formed in the first and second separator plates have a lesser diameter than the holes formed in the top caul plate.

Preferably, the system further includes first and second sheets positioned between the first and second separator plates, respectively, and the layers, the first and second sheets having holes formed therein corresponding to the registration holes formed in the layers.

Preferably, the first and second sheets are aluminium sheets.

Preferably, the circuit board layers include at least one of flexible circuit board layers and rigid circuit board layers.

Preferably, the holes and bores in the top and bottom caul plates are arranged in a grid pattern.

Preferably, the grid pattern has square cells.

Preferably, the square cells are one inch square.

### BRIEF DESCRIPTION OF THE DRAWINGS

Further features and advantages of the embodiments of the present invention will become apparent from the following detailed description, taken in combination with the appended drawings, in which:

FIG. 1 includes top and section views illustrating a top caul plate in accordance with an embodiment of the invention;

FIG. 2 includes top and section views illustrating a bottom caul plate in accordance with an embodiment of the invention;

FIG. 3 is a side view of a lamination book lay-up illustrating the lamination plate system in operation in accordance with an embodiment of the invention;

FIG. 4 is a computer aided manufacturing (“CAM”) plan illustrating the layout of flexible circuit boards to be laminated and corresponding registration pin locations in accordance with an embodiment of the invention; and,

FIG. 5 is a registration pin location plan illustrating registration pin locations in accordance with an embodiment of the invention.

It will be noted that throughout the appended drawings, like features are identified by like reference numerals.

### DETAILED DESCRIPTION OF THE PREFERRED EMBODIMENTS

In the following description, numerous specific details are set forth to provide a thorough understanding of the invention. However, it is understood that the invention may be practiced without these specific details. In other instances, well-known structures and techniques have not been described or shown in detail in order not to obscure the invention.

The present invention provides a lamination plate system having floating registration pins and a corresponding registration pin hole grid arrangement for registering flexible and rigid-flex printed circuit boards with respect to each other during lamination in a hydraulic press. The lamination plate system provides improved registration of printed circuit patterns through the used of multiple restraining points arranged with the pin hole grid.

The lamination plate system is adaptable for multiple circuit board designs. The floating pins and pin hole grid arrangement allows for the selection of multiple individualized restraining points for circuit boards. Advantageously, the lamination plate system of the present invention retains the registration properties of dedicated plate systems having multiple restraining points, as described above, but eliminates the need for the fabrication of dedicated plates for each new circuit board design.

As mentioned above, these dedicated plate systems often include a number of fixed registration pins surrounding and located as near as possible to the etched, printed pattern of the circuit boards for supporting the dielectric during lamination. A drawback of these dedicated plate systems is that they may unduly constrain the movement of circuit board materials during lamination. The expansion forces of the laminate may deform the registration holes when the pins are fixed in place. Depending on the material chosen for the registration pins, e.g. steel or aluminium, expansion forces can also act upon the laminate when the lamination plates expand when heated. These forces may produce imperfections in the final circuit board product. The present invention overcomes this drawback.

The lamination plate system 300 of the present invention includes a top caul plate 100, a bottom caul plate 200, a number of floating registration pins 310, a number of separator plates 341, 342, 343, and a number of predrilled aluminium sheets 391, 392, 393, 394.

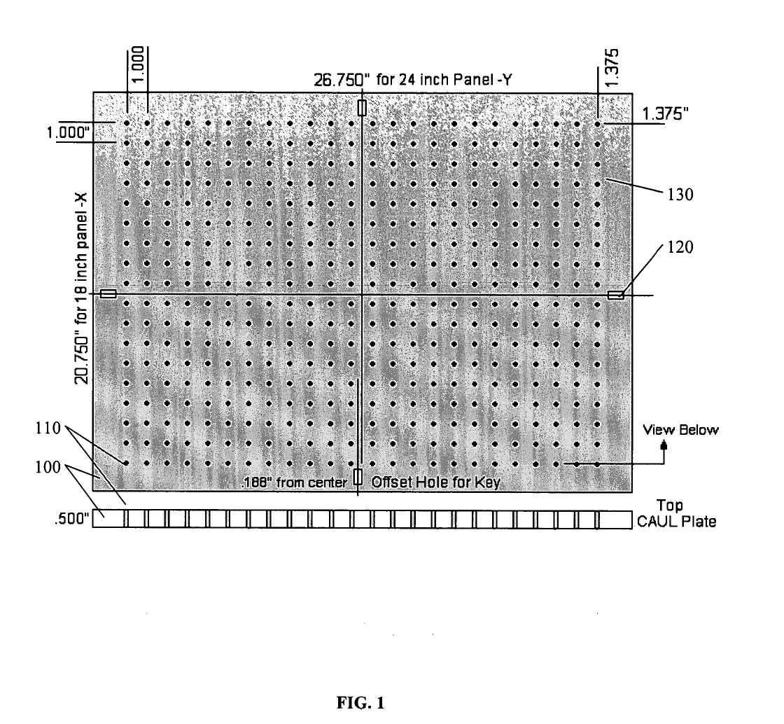

FIG. 1 includes top and section views illustrating a top caul plate 100 in accordance with an embodiment of the invention. The top caul plate 100 is generally rectangular in shape and typically may have a length (y-axis), width (x-axis), and depth (z-axis) of approximately 26.75, 20.75, and 0.5 inches, respectively. The top caul plate 100 includes a grid 130 of registration pin holes 110 formed through the plate 100 each for receiving the shaft 320 of a registration pin 310. The registration pin holes 110 are spaced approximately 1 inch apart along both the x-axis and y-axis and have a diameter of approximately 0.187 inches. The grid 130 is spaced approximately 1.375 inches along the x-axis and y-axis from the corner of the plate 100. The number of registration holes 110 in a typical top caul plate 100 is 24×18=432. The top caul plate 100 may also include 4 rectangular slots 120 for centering the plate 100 in a hydraulic press. The 4 slots 120 are for receiving standard Multiline® oblong pins 350 and are dimensioned 0.250 inches in diameter by 0.1875 inches in length and having flattened sides. The top caul plate 100 may be constructed with 0.5 inch flat stock MIC-6 aluminum or CR steel.

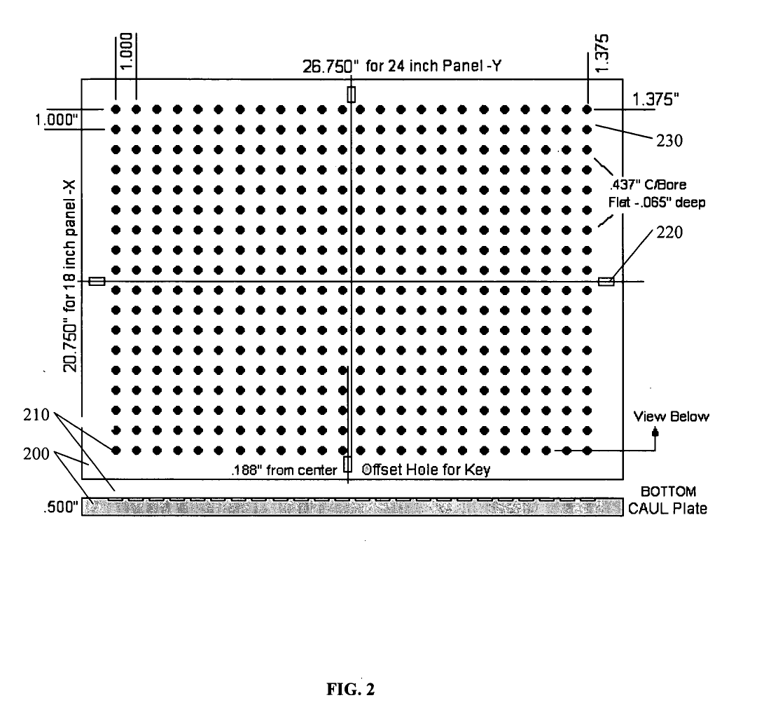

FIG. 2 includes top and section views illustrating a bottom caul plate 200 in accordance with an embodiment of the invention. The bottom caul plate 200 is generally rectangular in shape and typically may have a length (y-axis), width (x-axis), and depth (z-axis) of approximately 26.75, 20.75, and 0.5 inches, respectively. The bottom caul plate 200 includes a grid 230 of registration pin bores 210 formed in the plate 200 each for receiving the head 330 of a registration pin 310 during lay-up and lamination of a circuit board. The registration pin bores 210 of the bottom caul plate 200 correspond to the registration pin holes 110 of the top caul plate 100 also being spaced approximately 1 inch apart along both the x-axis and y-axis. Again, the grid 230 is spaced approximately 1.375 inches along the x-axis and y-axis from the corner of the plate 200. Each pin bore 210, rather than being drilled through the bottom caul plate 200, is a milled, flat counter bore of approximately 0.437 inches in diameter and 0.065 inches in depth. The number of registration bores 210 in a typical bottom caul plate 200 is 432, corresponding to the top caul plate 100. The bottom caul plate 200 may also include 4 rectangular slots 220, corresponding to the 4 rectangular slots 120 in the top caul plate 110, for centering the system 300 in a hydraulic press. Again, the 4 slots 220 are for receiving standard Multiline® oblong pins 350 and are dimensioned 0.250 inches in diameter by 0.1875 inches in length and having flattened sides. The bottom caul plate 200 may be constructed with 0.5 inch flat stock MIC-6 aluminum or CR steel.

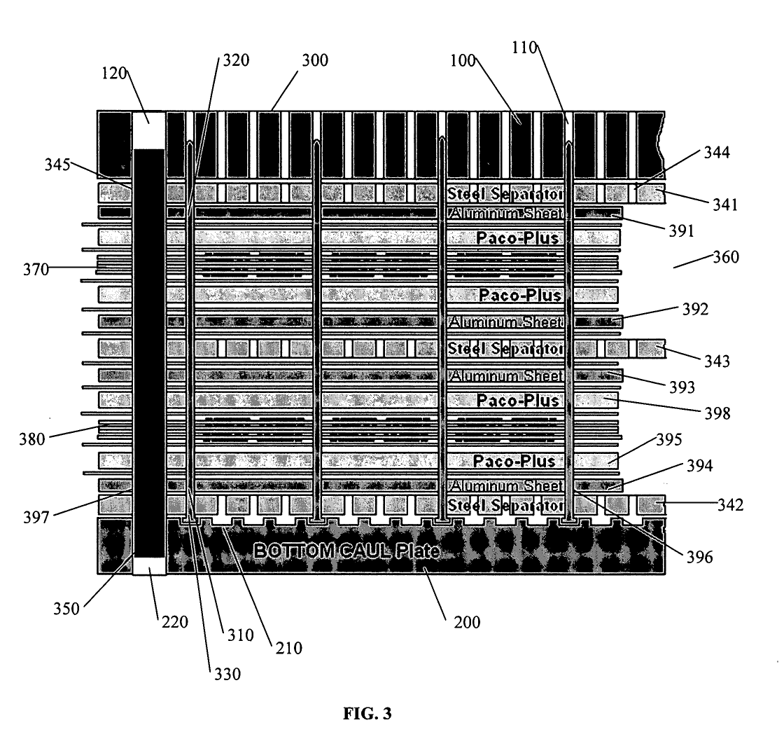

FIG. 3 is a side view of a lamination book or stack lay-up 360 illustrating the lamination plate system 300 in operation in accordance with an embodiment of the invention.

In FIG. 3, three separator plates 341, 342, 343 are shown. The first and second separator plates 341, 342 are located in the book lay-up 360 adjacent to the top and bottom caul plates 100, 200, respectively. The third separator plate 343 is located in the book 360 between multilayer board parts 370, 380 to be laminated. Of course, additional separator plates may be added if additional board parts are to be laminated.

Corresponding to the top and bottom caul plates 100, 200, each separator plate 341, 342, 343 is generally rectangular in shape and typically may have a length (y-axis), width (x-axis), and depth (z-axis) of approximately 26.75, 20.75, and 0.5 inches, respectively. Each separator plate 341, 342, 343 includes a grid (not shown) of registration pin holes 344 formed through the plate 341, 342, 343 each for receiving the shaft 320 of a registration pin 310. The registration pin holes 344 are spaced approximately 1 inch apart along both the x-axis and y-axis and have a diameter of approximately 0.128 inches, thus being lesser in diameter than the holes in the top caul plate 100. The grid is spaced approximately 1.375 inches along the x-axis and y-axis from the corner of the plate 341, 342, 343. The number of registration holes 344 in a typical separator plate 341, 342, 343 is 432. Each separator plate 341, 342, 343 may also include 4 rectangular slots 345 for centering the system 300 in a hydraulic press. The 4 slots 120 are for receiving standard Multiline® oblong pins 350 and are dimensioned 0.250 inches in diameter by 0.1875 inches in length and having flattened sides. Each separator plate 341, 342, 343 may be constructed with 19 gauge stainless steel type 316.

Each registration pin 310 has a shaft 320 with a diameter and length of approximately 0.1245 and 1.0 inches, respectively. The head 330 of each pin 310 has a flange with a diameter and thickness of approximately 0.375 and 0.055 inches, respectively.

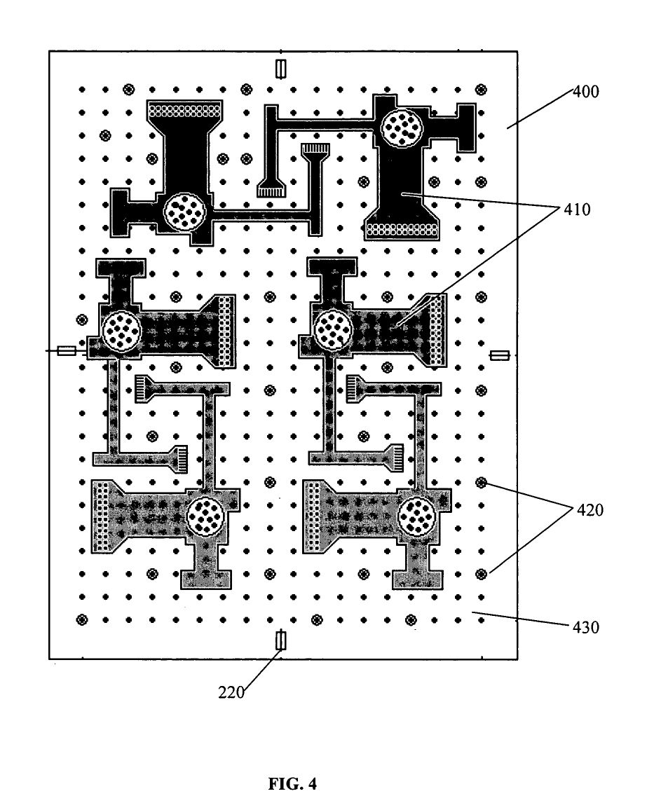

FIG. 4 is a computer aided manufacturing (“CAM”) plan 400 illustrating the layout of flexible circuit boards 410 to be laminated and corresponding registration pin locations 420 in accordance with an embodiment of the invention. The plurality of corresponding registration pin holes 110, 344 and bores 210 in the top and bottom caul plates 100, 200 and in the separator plates 341, 342, 343 allow for the placement in the CAM plan or artwork 400 of the flexible circuit boards 410 for the optimum use of material surface area, without compromising positioning of the circuit board design. The CAM plan 400 places each flexible circuit board in a location that will match existing tooling holes, thereby serving the dual purposes of: (a) pinning to ensure stability during lamination; and, (b) establishing location points for final die cutting of the circuit boards 410 when using steel rule dies. Since the registration pin holes of the lamination plate system 300 are located on a one inch grid 130, 230, 430, the placement of registration pin locations 420 can be accurately preformed.

In general, registration pin locations 420 are selected which are positioned closest to the circuit boards 410 and which correspond to the grid 130, 230, 430. These locations 420 should be similar for each flexible circuit 410 located in the CAM plan 400. As mentioned, some of the selected locations 420 can serve as pick-up pins for the final outline punch system and as such should have similar spacing from each flexible circuit 410. This will ensure that multiple steel rule dies will be able to die-cut the flexible circuit board material without inference.

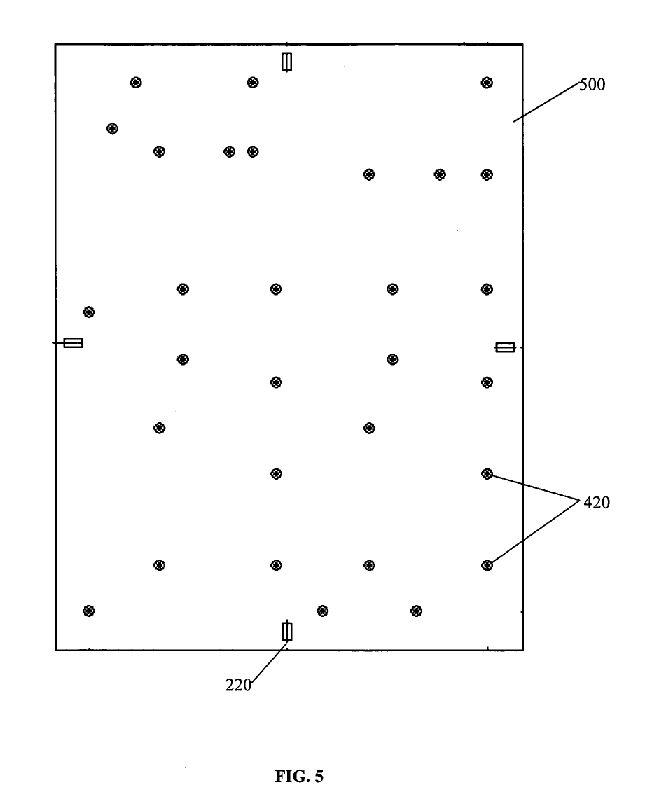

FIG. 5 is a registration pin location plan 500 illustrating registration pin locations 420 in accordance with an embodiment of the invention. Using the CAM plan 400, a registration pin location plan (or drill file) 500 is generated by a CAM system for controlling automated drills to produce the predrilled aluminium sheets 391, 392, 393, 394 and predrilled consumable lamination materials 395 shown in FIG. 3. The predrilled aluminium sheets 391, 392, 393, 394 and predrilled consumable lamination materials 395 have registration pin holes 396 corresponding to the registration pin locations 420 of the registration pin location plan 500. The diameter of each of these registration pin holes 396 is approximately 0.125 inches. Each predrilled aluminium sheet 391, 392, 393, 394 has a thickness of approximately 0.010 or 0.015 inches. Greater thicknesses will also work well. The predrilled consumable lamination materials 395 may include release sheets (e.g., Pacothane®, Skived Teflon®, etc.), pressure aids (e.g., Pacothane Plus®, polycarbonate plastic, etc.), and heat lag materials (e.g., Pacopads®, Kraft paper, etc.). All materials required for lamination are pre-drilled in conformance with the registration pin location plan 500.

Referring to FIG. 3, in operation, the lamination book lay-up 360 is built up as follows. A predrilled aluminium sheet 394 is overlaid on a separator plate 342. Registration pins 310 are then inserted through the registration pin holes 344 in the separator plate 342 that line-up with the registration pin holes 396 in the aluminium sheet 394. The bottom caul plate 200 is then positioned under the separator plate 342 such that the heads 330 of each pin rest in corresponding bores 210 in the bottom caul plate 200, the separator plate 342 thus lying flush on the bottom caul plate 200. The predrilled aluminium sheet 394 is thus on top of the separator plate 342 and bottom caul plate 200 and all registration pin holes 344 in the separator plate 342, except those corresponding to the registration pin holes 396 in the predrilled aluminium sheet 394 and having an inserted registration pin 310, are covered.

The bottom caul plate 200, separator plate 342, and predrilled aluminium sheet 394 are then secured with Multiline® oblong pins 350 inserted into the 4 rectangular slots 220, 345, 397 in the bottom caul plate 200 and separator plate 342 and predrilled into the aluminium sheet 394.

Next, predrilled consumable lamination materials 395 are added to the lamination book lay-up 360 including one or more of a release sheet, pressure aid, and an additional release sheet. This is followed by the addition of the multilayered flexible circuit board layers 380 including any related adhesive or bonding sheets as necessary.

The lay-up 360 nears completion by then adding a second layer of predrilled consumable lamination materials 398, followed by a second predrilled aluminium sheet 393, followed by a separator panel 343. Several circuit boards 370, 380 can be stacked in a single lamination book lay-up 360 by repeating the lay-up process described above. The number of circuit boards that can be stacked is only limited by the length of the registration pins 310 and the level of heat penetration desired for the boards.

The top caul plate 100 is added to complete the lay-up process. The lamination book lay-up 360 is now ready for lamination in a hydraulic press. After lamination is completed, the registration pins 310 are removed and the laminated boards are removed from the book 360 for further processing.

Advantageously, the predrilled aluminium sheets 393, 394 prevent pressure aid materials 395, 398 from penetrating the unused registration pin holes 344 in the separator plates 342, 343 and hence from the unused registration pin holes and bores 110, 210 in the top and bottom caul plates 100, 200.

Thus, the present invention provides a lamination plate system 300 capable of: holding the flexible and often unstable lamination materials used to fabricate flexible circuit boards with the necessary restrain (i.e., number of restraining points); allowing the lamination materials to expand and contract along the horizontal x-axis and y-axis directions during lamination; and, restraining the lamination materials along the vertical z-axis direction, thereby assuring that the etched circuit board images will remain in registration within the multilayer stack. By allowing the lamination materials to move horizontally and by restraining the lamination materials from moving vertically, registration is improved throughout the stack.

The registration pins 310 are allowed to move or “float” within their holes and bores 110, 210 in the top and bottom caul plates 100, 200 as the lamination materials undergo dimensional changes during the temperature excursions of the lamination process, specifically during the heat rise and cooling portions of the process. This free-floating action diminishes the adverse effects of the forces produced by the expanding lamination materials on the registration pins 310 and hence on the final circuit board product. In particular, the use of floating pins 310 avoids the deformation that occurs when fixed pins are used. Consequently, resulting hole locations match the drilled co-ordinates of the originally planned locations more accurately.

According to one embodiment of the invention, one or more of the separator plates 341, 342, 343 and predrilled aluminium sheets 391, 392, 393, 394 are allowed to float with the registration pins 310. According to another embodiment of the invention, the registration pins 310 are allowed to float within their holes 344, 396 in one or more of the separator plates 341, 342, 343 and predrilled aluminium sheets 391, 392, 393, 394.

The present invention may be readily adapted for use with larger or smaller sized panels, thereby more circuit boards may be accommodated. In addition, the invention may be practiced using heavier pins to take advantage of a larger surface area of each pin through increased pin diameter. This provides greater planar restraining strength for the flexible materials. Furthermore, the additional registration points made available by the present invention can be used during singulation, final trimming, die-cutting, marking, and screening of identification processes thereby reducing variations from finished part to finished part.

The present invention has several additional advantages as follows: the free floating registration pins 310 hold lamination materials only in the z-axis or vertical direction while providing multiple registration points; no new lamination tooling is required as the invention works with existing tooling equipment and hydraulic presses; registration is improved; costs are reduced as the use of dedicated, product specific lamination plates is avoided; storage space for such dedicated plates is reduced, further reducing costs; the registration properties of multiple pin tooling used by dedicated tooling systems is retained; material and labour costs required to produce dedicated lamination plates for each product design are avoided; lay-up speed is increased while standard lay-up methods may be retained; and, tooling hole distortion during lamination is reduced improving efficiency of downstream processes requiring precise hole locations.

The embodiment(s) of the invention described above is(are) intended to be exemplary only. The scope of the invention is therefore intended to be limited solely by the scope of the appended claims.

1. A lamination plate system for registering printed circuit board layers in a lamination press, the layers having a plurality of corresponding registration holes formed therein, the system comprising:
a plurality of respective pins for passing through the registration holes to register the layers vertically, each pin having a head and a shaft; and,
top and bottom caul plates having a plurality of corresponding holes and bores formed therein, respectively, each hole and bore for receiving the shaft and head of a pin, respectively;
wherein the pins, holes, and bores are sized to allow for horizontal movement of the layers when positioned between the top and bottom caul plates during lamination.

2. The system of claim 1 wherein the registration holes in the layers correspond to ones of respective holes and bores in the top and bottom caul plates.

3. The system of claim 2 and further comprising first and second separator plates positioned between the top and bottom caul plates, respectively, and the layers, the first and second separator plates having holes formed therein corresponding to the holes formed in the top caul plate.

4. The system of claim 3 wherein the holes formed in the first and second separator plates have a lesser diameter than the holes formed in the top caul plate.

5. The system of claim 3 and further comprising first and second sheets positioned between the first and second separator plates, respectively, and the layers, the first and second sheets having holes formed therein corresponding to the registration holes formed in the layers.

6. The system of claim 5 wherein the first and second sheets are aluminium sheets.

7. The system of claim 1 wherein the circuit board layers include at least one of flexible circuit board layers and rigid circuit board layers.

8. The system of claim 1 wherein the holes and bores in the top and bottom caul plates are arranged in a grid pattern.

9. The system of claim 8 wherein the grid pattern has square cells.

10. The system of claim 8 wherein the square cells are one inch square.
